(19) United States
(12) Patent Application Publication
(10) Pub. No.: US 2018/0178077 A1
(43) Pub. Date: Jun. 28, 2018

(54) GOLF BALL

(71) Applicant: Bridgestone Sports Co., Ltd., Tokyo (JP)

(72) Inventor: Atsushi NANBA, Chichibushi (JP)

(73) Assignee: Bridgestone Sports Co., Ltd., Tokyo (JP)

(21) Appl. No.: 15/822,379

(22) Filed: Nov. 27, 2017

(30) Foreign Application Priority Data
Dec. 28, 2016 (JP) 2016-254757

(51) Int. Cl. A63B 37/00; C08L 23/08

(52) U.S. Cl. CPC A63B 37/0029; C08L 2205/02; A63B 37/0063; A63B 37/0064; A63B 37/0067; A63B 37/0065; A63B 37/0043; A63B 37/0045; A63B 37/0031; A63B 37/008; A63B 37/0083; A63B 37/0087; A63B 37/0084; A63B 37/0075; A63B 37/0074; C08L 23/0876; C08L 2205/03; A63B 37/0024

(57) ABSTRACT

In a golf ball having a core and a cover consisting of a plurality of layers that encases the core, adhesion between adjoining cover layers is improved by judicious selection of the materials making up the cover layers, providing the ball with an improved durability to impact without diminishing the ball initial velocity.

### CROSS-REFERENCE TO RELATED APPLICATION

This non-provisional application claims priority under 35 U.S.C. § 119(a) on Patent Application No. 2016-254757 filed in Japan on Dec. 28, 2016, the entire contents of which are hereby incorporated by reference.

### TECHNICAL FIELD

This invention relates to a golf ball having a core encased by a cover consisting of a plurality of layers. More particularly, the invention relates to a golf ball in which adhesion between adjoining layers of the cover is enhanced, enabling the durability of the ball to cracking on impact to be improved without lowering the initial velocity of the ball.

### BACKGROUND ART

Solid golf balls with a multilayer construction of three or more pieces have come into frequent use in recent years, and even four-piece solid golf balls composed of a core encased by a cover of three or more layers, such as an envelope layer, an intermediate layer and an outermost layer, have made it onto the market. These multilayer golf balls are generally obtained by successively injection-molding synthetic resin cover materials around the core periphery so as to form a succession of individual layers over the core. However, when adhesion between the layers of the golf ball is poor, this may invite declines in various ball properties, such as the distance, spin rate on approach shots, feel at impact and durability to cracking. Hence, there exists a desire to improve adhesion between the layers.

Art for improving the durability of golf balls has been disclosed in a number of patent publications, one of which, JP-A H5-68724, describes the inclusion of an oxazoline group-containing thermoplastic resin in an ionomer resin-based cover material. This patent publication mentions that when an oxazoline group-containing thermoplastic resin is mixed into an ionomer resin under applied heat, the oxazoline groups in the thermoplastic resin react with carboxyl groups in the ionomer resin, causing the oxazoline group-containing thermoplastic resin to graft onto the surface of the ionomer resin, thus forming a compatible mixed system, or “polymer alloy,” of the oxazoline group-containing thermoplastic resin microdispersed within the ionomer resin. Synergistic improvements in the physical properties of this polymer alloy enable the toughness of the ionomer resin to be further improved, as a result of which the durability of the golf ball is enhanced.

However, the foregoing art relates to a three-piece golf ball having a core encased by a single cover layer made of an ionomer resin composition; it is not art relating to, as mentioned above, a solid golf ball having a multilayer construction of three or more pieces of the sort developed recently in pursuit of higher levels of performance for various properties of the ball other than flight. Nor is the foregoing art capable of improving the flight and durability of the ball by virtue of the adhesion strength between layers, such as the adhesion between an inside layer and an outside layer, within a cover having a plurality of layers.

### SUMMARY OF THE INVENTION

It is therefore an object of the present invention to provide a golf ball having a cover consisting of a plurality of layers, wherein the adhesion between adjoining layers is even further enhanced, enabling the durability on impact to be improved without lowering the initial velocity of the ball.

As a result of extensive investigations, I have discovered that, in a golf ball have a core encased by a cover consisting of a plurality of layers, by forming at least a first layer of the cover of primarily:
(A) one or more selected from the group consisting of olefin-unsaturated carboxylic acid random copolymers and/or olefin-unsaturated carboxylic acid-unsaturated carboxylic aid ester random copolymers, and metal ion neutralization products of olefin-unsaturated carboxylic acid random copolymers and/or metal ion neutralization products of olefin-unsaturated carboxylic acid-unsaturated carboxylic acid ester random copolymers, and
(B) an oxazoline group-containing acrylic polymer or styrene polymer, and forming at least one other cover layer adjoining the first cover layer primarily of a polyurethane material, the adhesion between these adjoining cover layers can be enhanced, as a result of which a high durability to impact can be obtained without lowering the initial velocity of the ball.

Accordingly, the invention provides a golf ball having a core and a cover consisting of a plurality of layers that encases the core, wherein at least a first layer of the cover is formed primarily of:

(A) one or more selected from the group consisting of olefin-unsaturated carboxylic acid random copolymers and/or olefin-unsaturated carboxylic acid-unsaturated carboxylic aid ester random copolymers, and metal ion neutralization products of olefin-unsaturated carboxylic acid random copolymers and/or metal ion neutralization products of olefin-unsaturated carboxylic acid-unsaturated carboxylic acid ester random copolymers, and

(B) an oxazoline group-containing acrylic polymer or styrene polymer, component (B) accounting for 1 to 35 wt % of the total weight of components (A) and (B); and another cover layer adjoining the first cover layer is formed primarily of a polyurethane material.

In a preferred embodiment of the golf ball of the invention, the polymer of component (B) has a number-average molecular weight (Mn) of from 1,000 to 100,000 and a weight-average molecular weight (Mw) of from 1,000 to 250,000.

In another preferred embodiment of the inventive golf ball, at least one constituent polymer in component (A) has an acid content of at least 18 wt %.

In yet another preferred embodiment of the invention, at least one constituent polymer in component (A) has a degree of neutralization of not more than 90%.

In a further preferred embodiment, at least one constituent polymer of component (A) is an olefin-unsaturated carboxylic acid random copolymer and/or an olefin-unsaturated carboxylic acid-unsaturated carboxylic acid ester random copolymer.

In a still further preferred embodiment, the core is formed of one or more layer and has a center hardness and a surface hardness which satisfy the following relationship:

core surface hardness (JIS-C)−core center hardness (JIS-C)≥20.

### Advantageous Effects of the Invention

The golf ball of the invention, by enhancing adhesion between adjoining layers of the ball cover consisting of a plurality of layers, can improve the durability of the ball to cracking without lowering the initial velocity of the ball.

### BRIEF DESCRIPTION OF THE DIAGRAMS

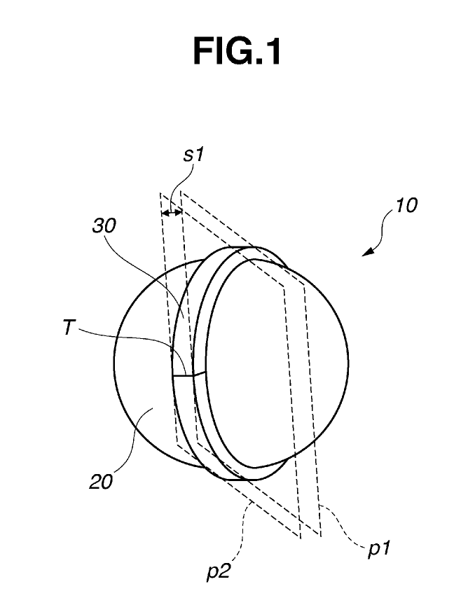

FIG. 1 is a diagram showing a test specimen used for measuring the adhesion strength between the intermediate layer and the outermost layer of a golf ball.

### DESCRIPTION OF THE PREFERRED EMBODIMENTS

The objects, features and advantages of the invention will become more apparent from the following detailed description, taken in conjunction with the foregoing diagram.

The golf ball of the invention has a core and a cover consisting of a plurality of layers encasing the core. The core used in this invention may consist of a single layer, may be a two-layer core having an inner layer and an outer layer, or may otherwise be formed of a plurality of layers.

The core may be formed using a known rubber composition. Although not particularly limited, preferred examples include rubber compositions formulated as described below.

The material forming the core may be composed primarily of a rubber material. For example, the core may be formed using a rubber composition which includes, together with a base rubber, such ingredients as a co-crosslinking agent, an organic peroxide, an inert filler, sulfur, an antioxidant and an organosulfur compound.

The use of polybutadiene as the base rubber of the rubber composition is preferred. The polybutadiene is preferably one having a cis-1,4 bond content on the polymer chain of at least 80 wt %, more preferably at least 90 wt %, and even more preferably at least 95 wt %. At a content of cis-1,4 bonds among the bonds on the polybutadiene molecule which is too low, the resilience may decrease. The polybutadiene has a content of 1,2-vinyl bonds on the polymer chain of preferably not more than 2 wt %, more preferably not more than 1.7 wt %, and even more preferably not more than 1.5 wt %. At a 1,2-vinyl bond content that is too high, the resilience may decrease.

To obtain a molded and vulcanized rubber composition having a good resilience, the polybutadiene included is preferably one synthesized with a rare-earth catalyst or a group VIII metal compound catalyst. Polybutadiene synthesized with a rare-earth catalyst is especially preferred.

Rubber components other than the above polybutadiene may be included in the rubber composition, insofar as the objects of the invention are attainable. Illustrative examples of rubber components other than the above polybutadiene include other polybutadienes and also other diene rubbers, such as styrene-butadiene rubber, natural rubber, isoprene rubber and ethylene-propylene-diene rubber.

Examples of co-crosslinking agents include unsaturated carboxylic acids and the metal salts of unsaturated carboxylic acids. Specific examples of unsaturated carboxylic acids include acrylic acid, methacrylic acid, maleic acid and fumaric acid. The use of acrylic acid or methacrylic acid is especially preferred. Metal salts of unsaturated carboxylic acids include, without particular limitation, the above unsaturated carboxylic acids that have been neutralized with desired metal ions. Specific examples include the zinc salts and magnesium salts of methacrylic acid and acrylic acid. The use of zinc acrylate is especially preferred.

The unsaturated carboxylic acid and/or metal salt thereof is included in an amount, per 100 parts by weight of the base rubber, which may be set to preferably at least 5 parts by weight, more preferably at least 10 parts by weight, and even more preferably at least 15 parts by weight. The amount included may be set to preferably not more than 60 parts by weight, more preferably not more than 50 parts by weight, and even more preferably not more than 45 parts by weight. Too much may make the core too hard, giving the ball an unpleasant feel at impact, whereas too little may lower the rebound.

The organic peroxide may be a commercially available product, specific examples of which include those available under the trade names Percumyl D, Perhexa 3M, Perhexa C-40, Niper BW and Peroyl L (all from NOF Corporation), and Luperco 231XL (from Atochem Co.). One of these may be used alone, or two or more may be used together.

The amount of organic peroxide included per 100 parts by weight of the base rubber is preferably at least 0.1 part by weight, more preferably at least 0.3 part by weight, even more preferably at least 0.5 part by weight, and most preferably at least 0.7 part by weight. The upper limit is preferably not more than 5 parts by weight, more preferably not more than 4 parts by weight, even more preferably not more than 3 parts by weight, and most preferably not more than 2 parts by weight. When too much or too little is included, it may not be possible to obtain a ball having a good feel, durability and rebound.

Examples of preferred inert fillers include zinc oxide, barium sulfate and calcium carbonate. One of these may be used alone, or two or more may be used together.

The amount of inert filler included per 100 parts by weight of the base rubber is preferably at least 1 part by weight, and more preferably at least 5 parts by weight. The upper limit in the amount included is preferably not more than 100 parts by weight, more preferably not more than 80 parts by weight, and even more preferably not more than 60 parts by weight. Too much or too little inert filler may make it impossible to obtain a proper weight and a good rebound.

In addition, an antioxidant may be optionally included. Illustrative examples of suitable commercial antioxidants include Nocrac NS-6, Nocrac NS-30 and Nocrac 200 (all available from Ouchi Shinko Chemical Industry Co., Ltd.), and Yoshinox 425 (available from Yoshitomi Pharmaceutical Industries, Ltd.). One of these may be used alone, or two or more may be used together.

The amount of antioxidant included can be set to more than 0, and may be set to an amount per 100 parts by weight of the base rubber which is preferably at least 0.05 part by weight, and more preferably at least 0.1 part by weight. The maximum amount included, although not subject to any particular limitation, may be set to an amount per 100 parts by weight of the base rubber which is preferably not more than 3 parts by weight, more preferably not more than 2 parts by weight, even more preferably not more than 1 part by weight, and most preferably not more than 0.5 part by weight. Too much or too little antioxidant may make it impossible to achieve a suitable core hardness gradient, a good rebound and durability, and a good spin rate-lowering effect on full shots.

An organosulfur compound may be optionally included in the rubber composition in order to enhance the core resilience. In cases where an organosulfur compound is included, the content thereof per 100 parts by weight of the base rubber may be set to preferably at least 0.05 part by weight, and more preferably at least 0.1 part by weight. The upper limit in the organosulfur compound content may be set to preferably not more than 5 parts by weight, more preferably not more than 4 parts by weight, and even more preferably not more than 2 parts by weight. Including too little organosulfur compound may make it impossible to obtain a sufficient core rebound-increasing effect. On the other hand, when too much is included, the core hardness may become too low, worsening the feel of the ball at impact, and the durability of the ball to cracking on repeated impact may worsen.

The rubber composition containing the various above ingredients is prepared by mixture using a typical mixing apparatus, such as a Banbury mixer or a roll mill. When this rubber composition is used to mold the core, molding may be carried out by compression molding or injection molding using a specific mold for molding cores. The resulting molded body is then heated and cured under temperature conditions sufficient for the organic peroxide and co-crosslinking agent included in the rubber composition to act, thereby giving a core having a specific hardness profile. The vulcanization conditions in this case are not particularly limited, although the vulcanization is typically set to from about 130° C. to about 170° C.

The diameter of the core, although not particularly limited, is preferably at least 20 mm, more preferably at least 25 mm, and even more preferably at least 30 mm, but is preferably not more than 41 mm, and more preferably not more than 40 mm.

The deflection of the core, expressed as the deformation when compressed under a final load of 1,275 N (130 kgf) from an initial load of 98 N (10 kgf), is preferably at least 2.0 mm, more preferably at least 2.5 mm, and even more preferably at least 2.7 mm, but is preferably not more than 6.0 mm, and more preferably not more than 5.0 mm. When this deformation is too small, the feel of the ball at impact becomes too hard. On the other hand, when this deformation is too large, the feel at impact becomes too soft or the durability of the ball to cracking under repeated impact worsens.

It is desirable for the core to have a hardness difference between the center hardness and the surface hardness thereof. Setting this hardness difference, expressed in terms of JIS-C hardness, to at least 20 is preferable for obtaining the desired initial velocity, feel at impact, spin properties and durability.

Next, the cover used in the golf ball of the invention is described. The cover is a member that encases the core and consists of a plurality of layers. Exemplary covers include two-layer covers and three-layer covers. Each layer of the cover is sometimes called a cover layer; in particular, the inner layer is called the intermediate layer and the outer layer is called the outermost layer. In the case of a three-layer cover, the respective layers are called, in order from the inside: the envelope layer, the intermediate layer and the outermost layer.

At least one layer of the cover (sometimes referred to herein as the “first cover layer”) is formed primarily of:

(A) one or more selected from the group consisting of olefin-unsaturated carboxylic acid random copolymers and/or olefin-unsaturated carboxylic acid-unsaturated carboxylic aid ester random copolymers, and metal ion neutralization products of olefin-unsaturated carboxylic acid random copolymers and/or metal ion neutralization products of olefin-unsaturated carboxylic acid-unsaturated carboxylic acid ester random copolymers; and

(B) an oxazoline group-containing acrylic polymer or styrene polymer. Another cover layer adjoining the first cover layer is formed primarily of a polyurethane material.

Here, the olefin in component (A) generally has at least two, but not more than eight, and especially not more than six, carbon atoms. Specific examples include ethylene, propylene, butene, pentene, hexene, heptene and octene. Ethylene is especially preferred.

Examples of the unsaturated carboxylic acid include acrylic acid, methacrylic acid, maleic acid and fumaric acid. Acrylic acid and methacrylic acid are especially preferred.

In addition, the unsaturated carboxylic acid ester is preferably a lower alkyl ester of the above unsaturated carboxylic acid. Specific examples include methyl methacrylate, ethyl methacrylate, propyl methacrylate, butyl methacrylate, methyl acrylate, ethyl acrylate, propyl acrylate and butyl acrylate. Butyl acrylate (n-butyl acrylate, i-butyl acrylate) is especially preferred.

It is recommended that the amount of unsaturated carboxylic acid included (acid content) in the olefin-unsaturated carboxylic acid copolymer of component (A) be generally at least 7 wt %, preferably at least 10 wt %, more preferably at least 12 wt %, even more preferably at least 15 wt %, and most preferably at least 18 wt %, but not more than 30 wt %, preferably not more than 25 wt %, and more preferably not more than 20 wt %. When the acid content of component (A) is low, that is, when there are few carboxyl groups, it may be difficult for the ionomer serving as component (A) and the oxazoline group-containing polymer serving as component (B) to form a crosslinked structure, and the compatibility of both polymers may worsen. As a result, there is a risk that the initial velocity of the ball will decrease. Moreover, in such a state of poor compatibility, there is a risk of failure arising at the surface of the layer which includes component (A) as a constituent material, and there is a risk that adhesion between the cover layers will be poor.

The metal ion neutralization product of the copolymer can be obtained by neutralizing some of the acid groups on the olefin-unsaturated carboxylic acid copolymer and/or olefin-unsaturated carboxylic acid-unsaturated carboxylic acid ester with metal ions. Here, the metal ions that neutralize the acid groups are exemplified by Na⁺, K⁺, Li⁺, Zn⁺⁺, Cu⁺⁺, M++++++++++g, Ca, Co, Ni, and Pb. It is especially preferable to use, for example, Na⁺, Li⁺, Zn⁺⁺, Mg⁺⁺ or Ca⁺⁺. Such neutralization products may be obtained by a known method. For example, the neutralization product can be obtained by using compounds such as formates, acetates, nitrates, carbonates, bicarbonates, oxides, hydroxides and alkoxides of the above metal ions.

At least one constituent polymer in component (A) has a degree of neutralization that is preferably not more than 90 mol %, and more preferably not more than 85 mol %. When this degree of neutralization is too high, as explained above concerning the range in the acid content, the ionomer and the oxazoline group-containing polymer have difficulty forming a crosslinked structure and the compatibility of both polymers worsen, which is undesirable.

Examples of the olefin-unsaturated carboxylic acid random copolymer and/or the olefin-unsaturated carboxylic acid-unsaturated carboxylic acid ester random copolymer of component (A) include Nucrel AN4319, AN4214C, N0823, N0903HC, N0908C, AN42012C, N410, N1035, N1050H, AN4229C, N1108C, N11081C, N1110H, N1214, AN4221C, N1525, N1560, N0200H, N035C, AN42115C, AN4213C, AN4228C and AN4233C (all products of DuPont-Mitsui Polychemicals Co., Ltd.). Examples of the polymer metal ion neutralization products of component (A) include Himilan 1554, 1557, 1601, 1605, 1706, AM7318, AM7311, 1855, 1856 and AM7316 (all products of DuPont-Mitsui Polychemicals, Co., Ltd.); Surlyn 6320, 8320, 9320 and 8120 (all products of E.I. DuPont de Nemours & Co.), and Iotech 7510 and 7520 (both products of Exxonmobil Chemical).

Sodium-based, zinc-based, magnesium-based and calcium-based ionomers may be concomitantly used in component (A). In such cases, the mixing ratio of the resin materials is not particularly limited.

Next, component (B) is described. Component (B) is an oxazoline group-containing acrylic polymer or styrene polymer, and primarily plays the role of a crosslinking agent that forms crosslinkages by reacting with the unsaturated carboxylic acid of component (A). In addition, with respect to the polyurethane material included in the subsequently described other cover layer, the oxazoline groups bond with urethane bonds within polyurethane that has thermally decomposed, enabling the oxazoline group-containing polymer to strongly adhere to the adjoining other cover layer.

The polymer of component (B) has a number-average molecular weight (Mn) that is preferably from 1,000 to 100,000, and more preferably from 10,000 to 80,000. The polymer of component (B) has a weight-average molecular weight (Mw) that is preferably from 1,000 to 250,000, and more preferably from 30,000 to 200,000. Outside of this range in the molecular weight, the compatibility with component (A) may worsen and the durability of the ball may decline. The weight-average molecular weight (Mw) and number-average molecular weight (Mn) are polystyrene-equivalent measured values obtained by gel permeation chromatography (GPC) using differential refractometry.

From the standpoint of achieving both the desired adhesive effect with the adjoining layer and the desired durability of the invention, the oxazoline group content within the polymer of component (B) is preferably from 0.1×10⁻³ to 10×10⁻³ mol/g (solids), and especially from 0.2×10⁻³ to 8×10⁻³ mol/g (solids), per 1.0 g of the polymer.

With regard to the amount of component (B) included, component (B) accounts for 1 to 35 wt % of the total weight of components (A) and (B). Setting this proportion in the range of 1 to 30 wt % is especially preferred for achieving both a good adhesive effect with the adjoining layer and a good ball durability.

A commercial product may be used as the polymer of component (B). Illustrative examples include the acrylic polymers Epocros WS-500, Epocros WS-300 and Epocros WS-700, all of which are available from Nippon Shokubai Co., Ltd.; and the styrene polymer Epocros RPS-1005, also available from Nippon Shokubai Co., Ltd.

The total amount of the base resin consisting of components (A) and (B) is not particularly limited, although it is recommended that this base resin account for at least 70 wt %, preferably at least 80 wt %, more preferably at least 90 wt %, and most preferably 100 wt %, of the overall amount of the resin composition. When this included amount of base resin falls short, the desired effects of the invention may not be achieved.

The resin composition can be obtained by mixing together the above-described components using various types of mixers, such as a kneading-type single-screw or twin-screw extruder, a Banbury mixer, a kneader or a Labo Plastomill.

In this invention, at least one other cover layer adjoining the first cover layer described above is formed primarily of a polyurethane material. The polyurethane material used here is not particularly limited, although the use of a thermoplastic polyurethane elastomer or a thermosetting urethane resin is preferred. The use of a thermoplastic polyurethane elastomer is especially preferred.

The polyurethane elastomer is not particularly limited, provided it is an elastomer composed primarily of polyurethane. A morphology that includes soft segments composed of a polymeric polyol compound and hard segments composed of a diisocyanate and a monomolecular chain extender is preferred.

Exemplary polymeric polyol compounds include, but are not particularly limited to, polyester polyols and polyether polyols. From the standpoint of rebound resilience or low-temperature properties, the use of a polyether polyol is preferred. Examples of polyether polyols include polytetramethylene glycol and polypropylene glycol, with the use of polytetramethylene glycol being especially preferred. These polyether polyols have a number-average molecular weight of preferably from 1,000 to 5,000, and more preferably from 1,500 to 3,000.

Exemplary diisocyanates include, but are not particularly limited to, aromatic diisocyanates such as 4,4′-diphenylmethane diisocyanate, 2,4-toluene diisocyanate and 2,6-toluene diisocyanate; and aliphatic diisocyanates such as hexamethylene diisocyanate. In the practice of this invention, from the standpoint of reaction stability with the subsequently described isocyanate mixture when blended therewith, the use of 4,4′-diphenylmethane diisocyanate is preferred.

The monomolecular chain extender is not particularly limited, although use can be made of an ordinary polyol or polyamine. Specific examples include 1,4-butylene glycol, 1,2-ethylene glycol, 1,3-propylene glycol, 1,3-butanediol, 1,6-hexylene glycol, 2,2-dimethyl-1,3-propanediol, 1,3-butylene glycol, dicyclohexylmethylmethanediamine (hydrogenated MDA) and isophoronediamine (IPDA). These chain extenders have average molecular weights of preferably from 20 to 15,000.

A commercial product may be used as the polyurethane elastomer. Illustrative examples include Pandex T7298, TR3080, T8230, T8290, T8293, T8295 and T8260 (all available from DIC Covestro Polymer, Ltd.), and Resamine 2593 and 2597 (available from Dainichiseika Color & Chemicals Mfg. Co., Ltd.). These may be used singly, or two or more may be used in combination.

In this invention, to comprehensively obtain the desired ball performance, it is preferable for a cover layer composed primarily of the above polyurethane material to be used as the outermost layer. When forming an outermost layer composed primarily of a polyurethane material, although not particularly limited, the surface of the intermediate layer made of components (A) and (B) may be subjected beforehand to abrasion treatment, or to plasma treatment or corona treatment. Plasma treatment or corona treatment removes contamination such as oil and fat ingredients from the intermediate layer surface and enables adhesion between the intermediate layer and the outermost layer to be improved owing to the introduction of polar functional groups.

Various additives may be optionally included in the materials that form the respective cover layers. For example, pigments, dispersants, antioxidants, light stabilizers, ultraviolet absorbers and internal mold lubricants may be suitably included.

The thicknesses of the respective layers, although not particularly limited, are preferably at least 0.5 mm, and more preferably at least 0.7 mm, but are preferably not more than 1.2 mm, more preferably not more than 1.1 mm, and even more preferably not more than 0.9 mm.

The hardnesses of the respective layers on the Shore D hardness, although not particularly limited, are set to preferably at least 30, and more preferably at least 40, but preferably not more than 75, more preferably not more than 70, and even more preferably not more than 65.

A known method may be used without particular limitation as the method of forming the layers of the cover. For example, use may be made of a method in which a pre-fabricated core or a sphere composed of the core encased by any of various layers is placed in a mold, and the resin material prepared as described above is injection-molded over the core or layer-encased sphere.

The ball has a deflection, measured as the deformation when the sphere is compressed under a final load of 1,275 N (130 kgf) from an initial load of 98 N (10 kgf), which is preferably at least 2.0 mm, and more preferably at least 2.5 mm, but is preferably not more than 4.0 mm, and more preferably not more than 3.8 mm. When this deformation value is too small, the feel of the ball at impact may be too hard. On the other hand, when this deformation value is too large, the feel at impact may be too soft or the durability to cracking on repeated impact may worsen.

Numerous dimples of one, two or more types may be formed on the surface of the cover. In addition, various types of coatings may be applied to the cover surface. Given the need for the golf ball to withstand harsh conditions of use, preferred examples of such coatings include two-part curing urethane coatings, especially non-yellowing urethane coatings.

Ball specifications such as the ball weight and diameter may be suitably set in accordance with the Rules of Golf.

### EXAMPLES

The following Working Examples and Comparative Examples are provided to illustrate the invention, and are not intended to limit the scope thereof.

### Working Examples 1 to 7, Comparative Examples 1 and 2

Using the following rubber composition shown in Table 1 below, which was common to all the Examples, solid cores for the respective Examples were produced by 15 minutes of vulcanization at 155° C.

TABLE 1

| Rubber core composition (C1) | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic Peroxide (1) | 0.6 |
| Organic Peroxide (2) | 1.2 |
| Zinc salt of | 0.3 |
| pentachlorothiophenol | |
| Zinc stearate | 1.0 |

Details on the above core materials are given below.
cis-1,4-Polybutadiene: Available under the trade name “BR01” from JSR Corporation.
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS-6” from Ouchi Shinko Chemical Industry Co., Ltd.
Organic Peroxide (1): Dicumyl peroxide, available under the trade name “Percumyl D” from NOF Corporation
Organic Peroxide (2): A mixture of 1,1-di(tert-butylperoxy)cyclohexane and silica, available under the trade name “Perhexa C-40” from NOF Corporation
Zinc stearate: Available from NOF Corporation

### Formation of Cover Layers (Intermediate Layer and Outermost Layer)

Next, intermediate layer-encased spheres were produced by using the resin materials formulated as shown in Table 2 below to injection-mold, over the 38.5 mm diameter cores obtained above, a 1.3 mm thick intermediate layer. Three-piece golf balls were then created by injection molding the outermost layer material shown in Table 3 below, which was common to all the Examples, to a thickness of 0.8 mm over the intermediate layer-encased sphere. At this time, a common arrangement of dimples was formed on the surface of the cover in each of the Working Examples and Comparative Examples.

TABLE 2

| | | | | | | | | Comparative | |
|---|---|---|---|---|---|---|---|---|---|
| | Working Example | | | | | | | Example | |
| | 1 | 2 | 3 | 4 | 5 | 6 | 7 | 1 | 2 |
| Intermediate layer material | Type | | | | | | | | |
| (pbw) | M1 | M2 | M3 | M4 | M5 | M6 | M7 | M8 | M9 |
| Na-based ionomer | 68.6 | 66.5 | 63.0 | 68.6 | 66.5 | 63.0 | 52.5 | 70.0 | 42.0 |
| Zn-based ionomer | 29.4 | 28.5 | 27.0 | 29.4 | 28.5 | 27.0 | 22.5 | 30.0 | 18.0 |
| Acid copolymer | | | | | | | 5.0 | | |
| Oxazoline Group-Containing | 2 | 5 | 10 | | | | | | |
| Polymer (1) | | | | | | | | | |
| Oxazoline Group-Containing | | | | 2 | 5 | 10 | 20 | 0 | 40 |
| Polymer (2) | | | | | | | | | |

Details on the materials mentioned in Table 2 are given below.
Na-based ionomer: A sodium-neutralized ethylene-unsaturated carboxylic acid copolymer having an acid content of 18 wt %
Zn-based ionomer: A zinc-neutralized ethylene-unsaturated carboxylic acid copolymer having an acid content of 15 wt %
Acid copolymer: An ethylene-unsaturated carboxylic acid copolymer having an acid content of 8 wt %

Oxazoline Group-Containing Polymer (1):
The acrylic polymer Epocros WS500 (insolubles content, 39 wt %; solvent, water/1-methoxy-2-propanol; oxazoline value, 220 g of solids/eq.; oxazoline group content, 4.5 mmol/g of solids; glass transition temperature, 50° C.; number-average molecular weight (Mn), 20,000; weight-average molecular weight (Mw), 70,000), available from Nippon Shokubai Co., Ltd.
Oxazoline Group-Containing Polymer (2):
   The styrene polymer Epocros RPS1005 (oxazoline group content, 0.27 mmol/g of solids; glass transition temperature, 109° C.; number-average molecular weight (Mn), 70,000; weight-average molecular weight (Mw), 160,000), available from Nippon Shokubai Co., Ltd.

TABLE 3

| Resin material of outermost layer (O1) | parts by weight |
|---|---|
| T-8290 | 75 |
| T-8283 | 25 |
| Hytrel 4001 | 12 |
| Titanium oxide | 3.5 |
| Isocyanate compound | 7.5 |

Trade names for the chief materials in Table 3 are given below.
T-8290, T-8283: Ether-type thermoplastic polyurethanes available under the trade name Pandex from DIC Covestro Polymer, Ltd.
Hytrel 4001: A polyester elastomer available from DuPont-Toray Co., Ltd.
Isocyanate compound: 4,4′-Diphenylmethane diisocyanate

Various properties of the resulting golf balls, including the diameters of the core, intermediate layer-encased sphere and ball, the thicknesses and material hardnesses of the respective layers, and the surface hardnesses and deformation under specific loading (deflection) of the various layer-encased spheres, were determined by the methods described below. The results are shown in Table 4. In addition, the initial velocity, adhesion and durability to impact of the golf balls produced in the respective Examples were evaluated by the following methods. The results are presented in Table 4.

### Diameter of Core and Intermediate Layer-Encased Sphere

The diameters at five random places on the surface were measured at a temperature of 23.9±1° C. and, using the average of these measurements as the measured value for a single inner core layer, core or intermediate layer-encased sphere, the average diameter for five measured specimens was determined.

### Ball Diameter

The diameters at five random dimple-free areas on the surface were measured at a temperature of 23.9±1° C. and, using the average of these measurements as the measured value for a single ball, the average diameter for five measured balls was determined.

### Deflection of Core, Intermediate Layer-Encased Sphere and Ball

The core, intermediate layer-encased sphere or ball was placed on a hard plate and the amount of deflection when compressed under a final load of 1,275 N (130 kgf) from an initial load of 98 N (10 kgf) was measured. The amount of deflection here refers in each case to the measured value obtained after holding the specimen isothermally at 23.9° C.

### Material Hardness (Shore D) of Intermediate Layer and Outermost Layer

The resin materials for the intermediate layer and the outermost layer were molded into sheets having a thickness of 2 mm and left to stand for at least two weeks, following which the Shore D hardness was measured in accordance with ASTM D2240-95.

### Initial Velocity

The initial velocity was measured using an initial velocity measuring apparatus of the same type as the USGA drum rotation-type initial velocity instrument approved by the R&A. The ball was temperature-conditioned for at least 3 hours at a temperature of 23±1° C., and then tested in a chamber at a room temperature of 23±2° C. Ten balls were each hit twice, the time taken for the ball to traverse a distance of 6.28 g (1.91 m) was measured, and the initial velocity was calculated. The initial velocity results shown in Table 4 are values relative to an arbitrary index of 100 for the initial velocity measured in Comparative Example 1.

### Adhesion Strength

Referring to FIG. 1, letting p1 be a plane at a distance of 2 mm from the center of a golf ball 10 and p2 be a plane having point symmetry with p1 through the ball center, the adhesion strength between the outermost layer 30 and the intermediate layer 20 was measured in the ball region s1 between the two planes p1 and p2. First, cuts T were made in the outermost layer 30 of the ball where p1 and p2 respectively intersect the outermost layer 30, and those portions of the outermost layer 30 other than s1 were peeled off. Next, a cut T perpendicular to p1 and p2 was made in the outermost layer 30 and, starting at this cut, about 20 mm of the outermost layer 30 was peeled from the intermediate layer 20, thereby obtaining a test specimen having a partially peeled strip thereon for gripping. The test was then carried out by gripping the strip provided in the outermost layer 30 with the movable clamp of a tensile tester. A test specimen-immobilizing fixture allows the test specimen to rotate while maintaining its center position, enabling the outermost layer 30 wrapped around the intermediate layer 20 to be peeled off without slack as the clamp moves away. Based on JIS K6256 (“Adhesion Test Method for Vulcanized Rubber and Thermoplastic Rubber”), the movable clamp of the tensile tester was moved at a speed of 50 mm/min and the tensile strength was measured at 0.1 mm intervals. The tensile strengths over an approximately 100 mm length of the outermost layer 30 were measured for each of three test specimens, and the average of the measured values for the three specimens was treated as the adhesion strength (units: N). The adhesion strength results shown in Table 4 are values relative to an arbitrary index of 100 for the adhesion strength obtained in Comparative Example 1. These adhesion strength results were rated according to the following criteria.

Very Good: larger than 200

Good: larger than 150 and up to 200

Somewhat Poor: larger than 100 and up to 150

Poor: up to 100

### Durability on Impact

The durability of the golf ball was evaluated using an ADC Ball COR Durability Tester produced by Automated Design Corporation (U.S.). This tester fires a golf ball pneumatically and causes it to repeatedly strike two metal plates arranged in parallel. The incident velocity against the metal plates was set to 43 m/s and the number of shots required for the golf ball to crack was measured. Durability values for the balls in the respective Examples were calculated relative to an arbitrary index of 100 for the number of shots taken with the ball obtained in Comparative Example 1.

TABLE 4

| | | | | | | | | | Comparative | |
|---|---|---|---|---|---|---|---|---|---|---|
| | | Working Example | | | | | | | Example | |
| | | 1 | 2 | 3 | 4 | 5 | 6 | 7 | 1 | 2 |
| Core | Composition | C1 | C1 | C1 | C1 | C1 | C1 | C1 | C1 | C1 |
| | Diameter (mm) | 38.5 | 38.5 | 38.5 | 38.5 | 38.5 | 38.5 | 38.5 | 38.5 | 38.5 |
| | Weight (g) | 34.5 | 34.5 | 34.5 | 34.5 | 34.5 | 34.5 | 34.5 | 34.5 | 34.5 |
| | Deflection (mm) | 3.5 | 3.5 | 3.5 | 3.5 | 3.5 | 3.5 | 3.5 | 3.5 | 3.5 |
| Intermediate | Composition | M1 | M2 | M3 | M4 | M5 | M6 | M7 | M8 | M9 |
| layer | Shore D hardness | 67 | 65 | 65 | 65 | 65 | 66 | 66 | 67 | 67 |
| Intermediate- | Diameter (mm) | 41.1 | 41.1 | 41.1 | 41.1 | 41.1 | 41.1 | 41.1 | 41.1 | 41.1 |
| layer | Weight (g) | 40.6 | 40.6 | 40.6 | 40.6 | 40.6 | 40.6 | 40.6 | 40.6 | 40.6 |
| encased | Deflection (mm) | 3.0 | 3.0 | 3.0 | 3.0 | 3.0 | 3.0 | 3.0 | 3.0 | 3.0 |
| sphere | | | | | | | | | | |
| Outermost | Composition | O1 | O1 | O1 | O1 | O1 | O1 | O1 | O1 | O1 |
| layer | Shore D hardness | 47 | 47 | 47 | 47 | 47 | 47 | 47 | 47 | 47 |
| Ball | Diameter (mm) | 42.7 | 42.7 | 42.7 | 42.7 | 42.7 | 42.7 | 42.7 | 42.7 | 42.7 |
| | Weight (g) | 45.4 | 45.4 | 45.4 | 45.4 | 45.4 | 45.4 | 45.4 | 45.4 | 45.4 |
| | Deflection (mm) | 2.6 | 2.6 | 2.6 | 2.6 | 2.6 | 2.6 | 2.6 | 2.6 | 2.6 |
| | Initial velocity | 100 | 100 | 100 | 100 | 100 | 100 | 100 | 100 | 99.5 |
| | (index) | | | | | | | | | |
| Adhesion | Strength | 250 | 250 | 250 | 159 | 159 | 167 | 167 | 100 | 159 |
| between | Rating | very | very | very | good | good | good | good | poor | good |
| intermediate | | good | good | good | | | | | | |
| layer and | | | | | | | | | | |
| outermost | | | | | | | | | | |
| layer | | | | | | | | | | |

| | | | | | | | | | |
|---|---|---|---|---|---|---|---|---|---|
| Durability of ball to repeated | 105 | 109 | 100 | 107 | 107 | 102 | 108 | 100 | 50 |
| impact (index) | | | | | | | | | |

As shown in Table 4, in Working Examples 1 to 3 containing suitable amounts of component (B), the balls showed no decrease in the initial velocity relative to Comparative Example 1 which contained no component (B) and the durability on impact was maintained at a level of performance at least comparable with that in Comparative Example 1. At the same time, a high level of adhesion between the intermediate layer and the outermost layer was achieved. Likewise, in each of Working Examples 4 to 7, as in Working Examples 1 to 3, a good initial velocity performance, good durability at impact, and good adhesion between the intermediate layer and the outermost layer were achieved. In Comparative Example 2 wherein the amount of component (B) was excessive, the durability of the ball to impact was poor.

Japanese Patent Application No. 2016-254757 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a core and a cover consisting of a plurality of layers that encases the core, wherein at least a first layer of the cover is formed primarily of:
(A) one or more selected from the group consisting of olefin-unsaturated carboxylic acid random copolymers and/or olefin-unsaturated carboxylic acid-unsaturated carboxylic aid ester random copolymers, and metal ion neutralization products of olefin-unsaturated carboxylic acid random copolymers and/or metal ion neutralization products of olefin-unsaturated carboxylic acid-unsaturated carboxylic acid ester random copolymers, and
(B) an oxazoline group-containing acrylic polymer or styrene polymer, component (B) accounting for 1 to 35 wt % of the total weight of components (A) and (B); and another cover layer adjoining the first cover layer is formed primarily of a polyurethane material.

2. The golf ball of claim 1, wherein the polymer of component (B) has a number-average molecular weight (Mn) of from 1,000 to 100,000 and a weight-average molecular weight (Mw) of from 1,000 to 250,000.

3. The golf ball of claim 1, wherein at least one constituent polymer in component (A) has an acid content of at least 18 wt %.

4. The golf ball of claim 1, wherein at least one constituent polymer in component (A) has a degree of neutralization of not more than 90%.

5. The golf ball of claim 1, wherein at least one constituent polymer of component (A) is an olefin-unsaturated carboxylic acid random copolymer and/or an olefin-unsaturated carboxylic acid-unsaturated carboxylic acid ester random copolymer.

6. The golf ball of claim 1, wherein the core is formed of one or more layer and has a center hardness and a surface hardness which satisfy the following relationship:
core surface hardness (JIS-C)−core center hardness (JIS-C)≥20.
